(19) United States
(12) Patent Application Publication
(10) Pub. No.: US 2009/0320074 A1
(43) Pub. Date: Dec. 24, 2009

(54) Information system and method

(75) Inventor: John G. Gawel, Franklin, TN (US)

Correspondence Address: NIXON & VANDERHYE, PC, 901 NORTH GLEBE ROAD, 11TH FLOOR, ARLINGTON, VA, 22203, US

(73) Assignee: TOSHIBA AMERICA CONSUMER PRODUCTS L.L.C., Wayne, NJ (US)

(21) Appl. No.: 12/219,930

(22) Filed: Jul. 30, 2008

Related U.S. Application Data
(60) Provisional application No. 61/129,335, filed on Jun. 19, 2008.

(51) Int. Cl. H04N 5/445

(52) U.S. Cl. 725/54

(57) ABSTRACT

Example systems and methods provide information such as, but not limited to, interactive program guide (IPG) information for display on a display device such as a television. In the case of IPG information, an IPG server includes an IPG data store that stores IPG data such as program titles, actors, program descriptions, program start times, program end times, program duration, and the like. Receivers such as televisions and set-top boxes are configured to have an electronic mailbox. In response to a request to display the IPG, an IPG data request is sent via a wide area network such as the internet to the IPG server. The server accesses the IPG data store and retrieves IPG data corresponding to the request. The retrieved IPG data is sent to the television's electronic mailbox as an e-mail message. Using the data contained in the e-mail message, the television generates and displays an IPG on the television screen.

### CROSS REFERENCE TO RELATED APPLICATION

This application claims the benefit of provisional application No. 61/129,335 filed Jun. 19, 2008, the contents of which are incorporated herein in their entirety.

### BACKGROUND AND SUMMARY

This patent application generally relates to information systems such as interactive program guides (IPGs) and, more particularly, to information systems such as interactive program guides in which information (e.g., program guide data) is accessible over a wide area network such as the internet. This application also describes implementing control of devices such as consumer electronic products over a wide area network.

Interactive program guides (IPGs) have been developed to allow television viewers to determine what programs are on at a specific time. Generally speaking, these IPGs display listings of programs on the television screen. The listings are typically organized by channel and time and often allow a viewer to obtain information about particular programs including, for example, the names of the actors in the program, a brief description of the program, etc. Some of these IPGs allow a viewer to select certain programs for present or future recording.

This patent application describes systems and methods in which information such as, but not limited to, program guide data is received over a wide area network such as the internet.

By way of example without limitation, an IPG server is accessible via the internet. The IPG server includes an IPG data store that stores IPG data such as program titles, actors, program descriptions, program start times, program end times, program duration, program rating, reviews and any other desired program-related information. Receivers such as televisions and set-top boxes are configured to have an electronic mailbox such as one compliant with the Instant Message Access Protocol (IMAP). The receivers also store a display template used for displaying the IPG data. This template may, for example, be a grid in which each row is associated with a particular channel and each column is associated with a specified time period (e.g., from 8:00 to 8:30 PM).

In response to a request to display the IPG (e.g., from a user or viewer), a program guide data request is sent (e.g., as an e-mail message) via the internet to the IPG server. The server accesses the IPG data store and retrieves IPG data corresponding to the request. The retrieved IPG data is sent to the receiver's electronic mailbox as an e-mail message. Using the data contained in the e-mail message, the receiver generates an IPG display and displays the IPG on the television screen. In one example, the IPG display may be generated by populating an IPG grid template.

When the viewer navigates within the IPG so as to necessitate a change in the displayed screen (such as moving the IPG forward in time, moving the IPG to see programs on different channels), another e-mail message is sent to the IPG data store to get updated information. The IPG data server responds via an e-mail message with the requested data and the IPG is refreshed.

In one example implementation, the IPG server may supply IPG data sufficient to generate an initial IPG display along with IPG data for programs “surrounding” this initial display to improve navigation response time. For example, if an IPG is configured to display programs on channels 5, 7 and 9 over a two-hour time period, the IPG server may supply IPG data for this two-hour time period along with IPG data for a subsequent time period (e.g., the next hour) or a previous time period. Thus, if a viewer were to navigate forward in time past the initially displayed two-hour period (e.g., to the next half-hour), the receiver can generate a new IPG display using already-received data. At the same time as the viewer navigates to the next half-hour, the receiver can send a request to the IPG server for IPG data for a further subsequent time period so that this IPG data is already available should the viewer continue to navigate forward in time.

Similarly, the IPG server may additionally or alternatively supply IPG data for channels immediately higher and lower than the channels currently included in the IPG display. In the above example, where IPG data for channels 5, 7 and 9 is displayed, the IPG server may supply IPG data for channels 2, 4, 11 and 13. In this way, if a viewer navigates to higher or lower channels within the IPG (e.g., to channel 4), the receiver can generate an IPG display based on already-received IPG data. Here again, at the same time as the viewer navigates to these higher or lower channels, the receiver can send a request to the IPG server for additional higher and lower channels (as appropriate) so that this IPG data is already available should the viewer continue to navigate to higher or lower channels.

The systems and methods described herein are not limited to IPG displays for multiple channels/times. For example, the receiver can generate an request for IPG data (e.g., program title, program summary, actor information and starting and ending times) relating to a program on a currently-tuned channel. This information can be provided as an overlay to the program on the currently-tuned channel.

Indeed, the systems and methods described herein are not limited to IPG data and may be applied to other types of data intended for display on a television (e.g., news stories, sports scores, weather reports, financial information, etc.).

In some implementations, the viewer may use the IPG to schedule the recording of certain programs. Data relating to this recording (e.g., start time, end time, channel, etc.) may be sent via an e-mail message to the IPG server. The IPG server stores the recording request and, at an appropriate time, sends a message to the receiver indicating the time, input and channel that the viewer has previously selected for recording. The receiver responds to this message to enable the recording (e.g., by tuning the appropriate channel and turning on a recording device).

These and other features and advantages of the systems and methods described herein will be better understood from a reading of the following detailed description in conjunction with the accompanying drawings.

### BRIEF DESCRIPTION OF THE DRAWINGS

FIG. 1 is a block diagram of an illustrative system in which the example IPG systems and methods described herein may be implemented.

FIGS. 2A and 2B show example grids in which IPG data may be displayed.

FIG. 3 shows a grid template populated with program titles.

FIG. 4 is a flow chart showing an example method of providing an IPG display.

### DETAILED DESCRIPTION OF EXAMPLE EMBODIMENTS

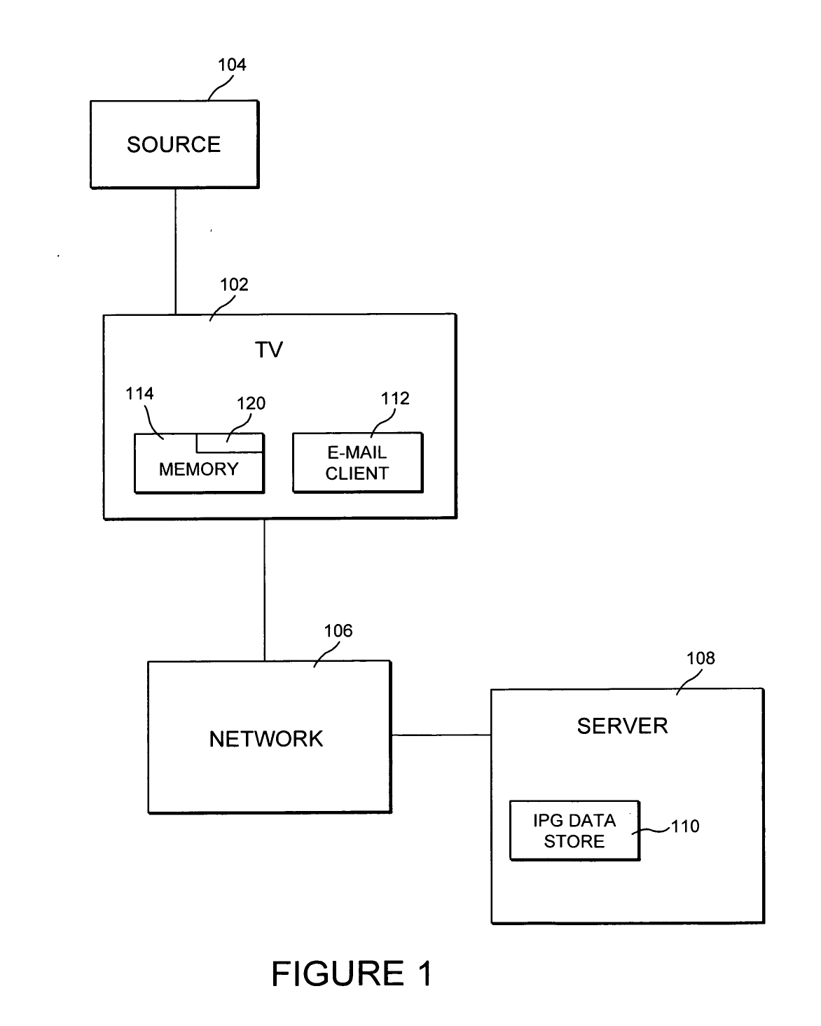

FIG. 1 is a block diagram of an illustrative system in which the example systems and methods described herein may be implemented.

A television 102 is connected to a source 104 of television signals. Source 104 may be a satellite receiver or an over-the-air antenna. Source 104 may also be a source of cable television signals. These signals may be provided via a set-top box or, in the case of a cable-ready television, may be directly input to television 102. Television 102 may be a flat-panel television such as an LCD or plasma television.

Television 102 is also connected to an IPG server 108 via a wide area network 106 such as the internet. The connection of the television to wide area network 106 may take a variety of forms. For example, television 102 may connect by wire or wirelessly to an access point (not shown) that provides access to the internet. By way of illustration, television 102 may include a wireless communication circuit conforming to a wireless protocol (e.g., 802.11(b), (g) or (n)) for connecting to a wireless access point. In another arrangement, television 102 may be connected in a home network that provides for internet access. For example, the Digital Living Network Alliance has published interoperability guidelines for networking consumer electronic products (such as televisions), personal computers, mobile phones and the like.

In another implementation, source 104 may be a bidirectional system (e.g., a bidirectional cable television system) and television 102 may access a wide area network such as the internet via this bidirectional system. In this case, television 102 may access the wide area network via a cable modem coupled to a port (e.g., a USB port, a 1394 port, etc.) thereof.

Server 108 may include one or more server computers or a server farm. Server 108 includes an IPG data store 110 that stores IPG data. The IPG data may be obtained from an IPG data provider (e.g., by downloading, over the internet, via satellite, etc.) and may include IPG data for the channel line-ups offered by one or more service providers. By way of example and without limitation, this IPG data may include program titles, program start times, program end times, program durations, program descriptions, closed captioning availability, second audio program (SAP) availability, high definition (HD) indicator, program rating (e.g., TV-Y, TV-14, etc.), actor information, program genre, critics' reviews and the like.

Server 108 may store other data as described below including, by way of example and without limitation, sports information (e.g., scores), financial information (e.g., stock prices), weather information (e.g., forecasts) and news information (e.g., headlines).

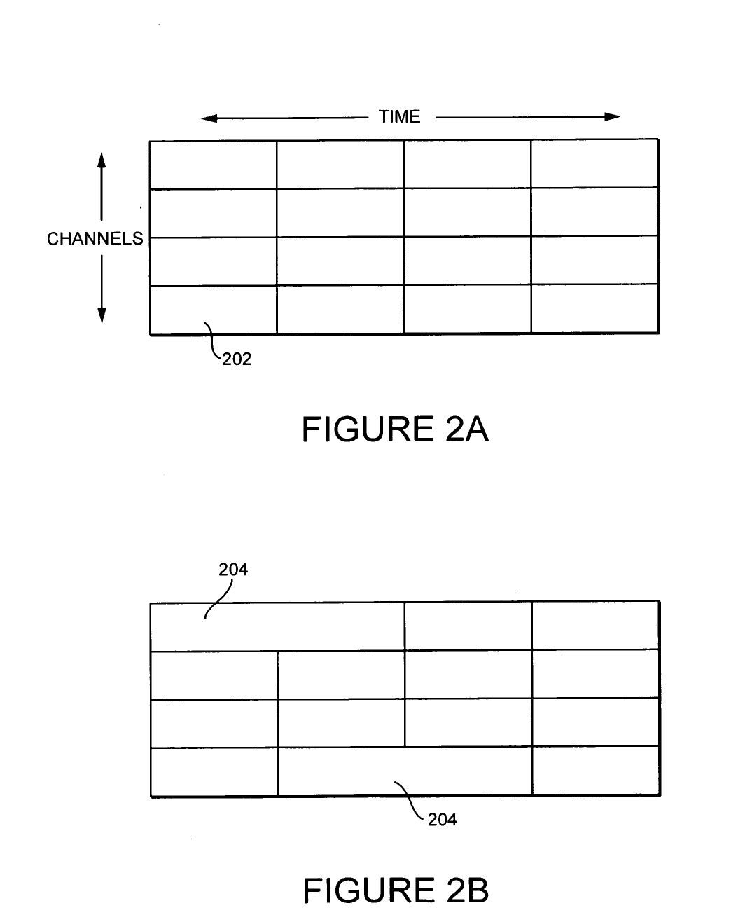

Television 102 includes an e-mail client 112 and a memory 114. Memory 114 stores IPG display templates. FIG. 2A shows an example “grid” template in which rows are respectively associated with particular channels and columns are associated with time periods. In FIG. 2A, each time period is shown as being ½-hour in duration. For programs on a given channel that are longer than ½-hour, two or more cells 202 may be merged into a single cell 204 as shown in FIG. 2B. It will also be apparent that the size and positions of the cells may be modified to accommodate for programs of different durations and different start/end times. This may be accomplished by modifying a default template such as that shown in FIG. 2A or by storing in memory 114 a plurality of templates having different cell arrangements.

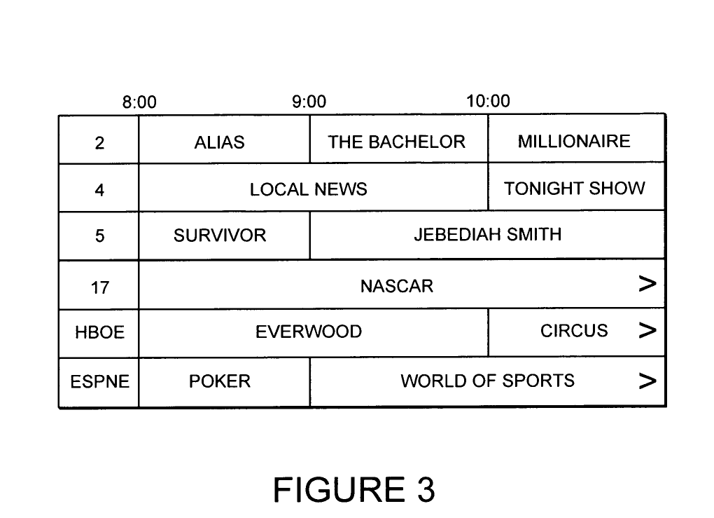

E-mail client 112 sets up a mailbox 120 in memory 114 that receives from IPG server 108 e-mail messages which include IPG data. Based on this IPG data and a control program executed by a controller or processing system (not shown) of television 102, an appropriate display template is generated (or selected) and the template is populated using the IPG data in the mailbox. For example, the cells of a grid template may be populated with program titles associated with particular channels at particular times as shown in FIG. 3. In particular, FIG. 3 shows that “Alias” is on channel 2 beginning at 8:00 PM and lasts for one hour; “The Bachelor” is on channel 2 beginning at 9:00 PM and lasts for one hour; and “Who Wants to be a Millionaire” is on channel 2 beginning at 10:00 PM and lasts for one hour. The grid template of FIG. 3 also identifies the titles of programs on channels 4, 5, 17, HBOE and ESPNE between 8:00 PM and 11:00 PM.

The viewer may provide inputs to television 102 (e.g., via a remote control) to move a cursor around the grid template, for example, to position a cursor or highlight on a particular program. By providing a specified input when a particular program is highlighted, the control program of the television accesses mailbox 120 and causes a description of the particular program to be displayed. Other inputs may be supplied to set a program timer so that a particular program is tuned to when it airs or to set a recording timer so that a particular program is recorded when it airs. These functions will be described in greater detail below.

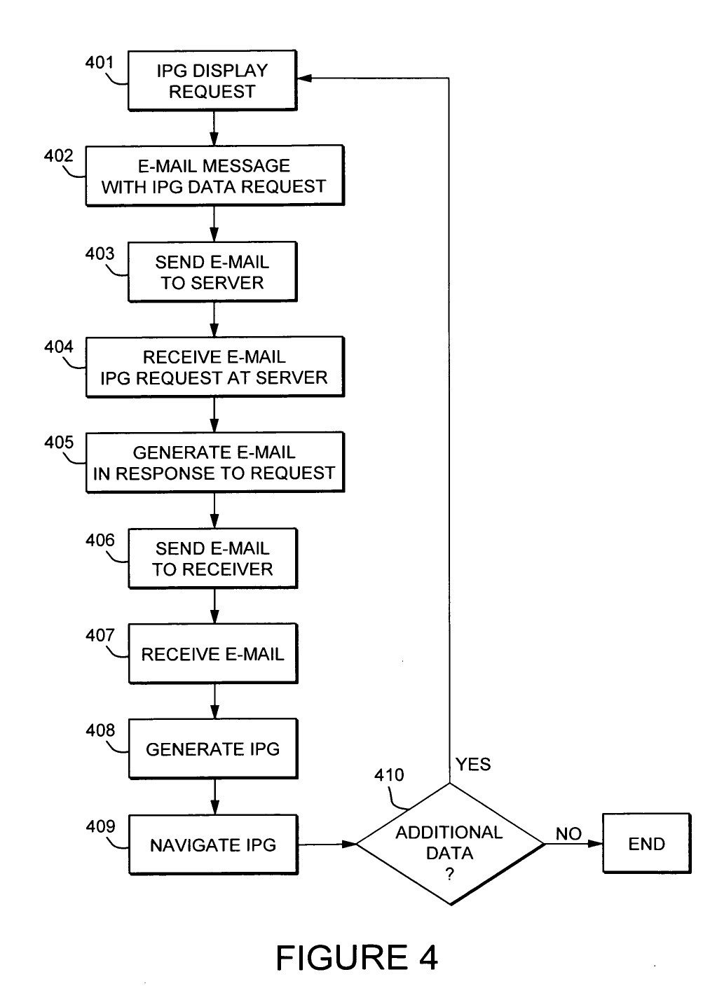

By way of example and without limitation, an illustrative method of providing an IPG display will be discussed with reference to FIG. 4.

At ST 401, television 102 receives an IPG display request. This display request may be supplied, for example, using a remote control or using a keypad provided as part of the television itself. By way of illustration, the remote control may include a “GUIDE” key that is pressed to invoke a request for display of an IPG on the television screen. In other implementations, the IPG display request may be automatically generated such as when power is turned on, when a channel is changed, or when a current program ends. In still other implementations, a voice recognition interface may be used in which a viewer speaks to request display of an IPG.

In response to the IPG display request, the control program of television 102 uses the e-mail client to generate one or more e-mail messages comprising a request for IPG data at ST 402. An example of the contents of a generated e-mail message are shown below:
Request: Grid data. Start time: 20:00. Duration: 3 hours. Channels: Nashville 2, Nashville 4, Nashville 5, Nashville 17, HBO East, ESPN East.[END]

The e-mail message shown above is an English-readable version. This message could also be packed or encoded in a machine-readable binary fashion and may optionally be encrypted. The request in the e-mail message indicates that the IPG display request is for “grid data” to populate a grid like that discussed above with reference to FIGS. 2 and 3. The start time portion indicates that the IPG display should begin at 20:00 (8:00 PM). The duration portion indicates that the IPG display should span three hours. The channel portion provides a list of the channels for which IPG data is required.

The contents of the various message portions discussed above may be set by default by the control program of the television or may be configured by the viewer. The start time portion may be determined with reference to the current time. By way of example, the default start time may be set as the nearest previous half-hour. Thus, if the current time is 8:22 PM, the nearest previous half-hour is 8:00 PM. If the current time is 8:44 PM, the nearest previous half-hour is 8:30 PM. The viewer may, if desired, specify other start time values such as nearest previous hour, nearest following half-hour, nearest following hour, and the like.

The default setting for the duration of time for which programs are shown in the grid may be three hours. The viewer may vary this default setting to other values such as two and one-half hours or two hours. Depending on the factors such as screen size, aspect ratio and resolution, the control program may set an upper limit on the duration so that the IPG display is not distorted by selecting a duration that is too large.

The channel portion may be determined with reference to the currently tuned channel. By way of example, the default setting may be to show programs on the currently tuned channel on a particular row of the grid (e.g., the top row, a middle row, etc.). The viewer may, if desired, specify some other arrangement. For example, the viewer may specify that the grid always be initially displayed with programs on the lowest available channel (e.g., channel 2) on the top row of the grid. As another example, the viewer may set up a list of “favorite” channels to populate the channel portion of the IPG e-mail message.

The e-mail messages may include alternative or additional message portions. These alternative or additional message portions need not be limited to or even related to IPG data. For example, a fan of a particular team may configure the control program of television 102 to include a message portion requesting a current score of any game being played by that team. Assuming server 108 stores or can access such information, this score information may be provided, for example, as an overlay to an IPG display or one or more rows of the IPG grid display may be used to display the score. This feature is not limited to sports information, but may be used to request financial information regarding particular stocks (e.g., price), current weather conditions, current news headlines, etc. assuming such information is stored by, or is accessible to, server 108. Here again, such information may be displayed as an overlay to the IPG display or within one or more rows of an IPG grid display.

In alternative implementations, the control program of television 102 may generate display requests for such sports, financial, weather, news, etc. information independent of any requests for IPG data. Such display requests may be sent to servers other than IPG server 108. Thus, a viewer watching a program and interested in a current score for his or her favorite team may simply initiate a display request for such information which is sent by an e-mail message to a server which responds with the requested information. This information can then be overlaid onto the currently viewed program.

After generating the one or more e-mail messages at ST 403, e-mail client 112 of television 102 sends the e-mail message over wide area network 106 to IPG server 108. The e-mail message is addressed to an e-mail address specified by the control program of television 102 which corresponds to IPG server 108. E-mail client 112 may comply with one or more of various e-mail protocols. The Internet Message Access Protocol (IMAP) is particularly advantageous because of the speed with which e-mail messages can be accessed. A current version of IMAP is IMAP version 4 revision 1 (IMAP4rev1) (see RFC 3501). Of course, the systems and methods described herein are not limited to any particular e-mail protocol.

At ST 404, IPG server 108 receives the one or more e-mail messages sent over wide area network 106 from e-mail client 112 of television 102. The control program of the IPG server 108 extracts the various portions of the e-mail message (e.g., the request portion, the start time portion, the duration portion and the channel portion) and uses these extracted portions to retrieve appropriate IPG data from IPG data store 110. For example, using the contents of the message shown above, the control program of IPG server 108 retrieves IPG data for programs on channels 2, 4, 5, 17, HBOE, and ESPNE during a three-hour period starting at 20:00 (8:00 PM). The retrieved IPG data may include without limitation program titles, program start times, program end times, program durations, program descriptions, closed captioning availability, SAP availability, high definition (HD) indicator, program rating (e.g., TV-Y, TV-14, etc.), actor information, program genre, critics' reviews and the like.

At ST 405, the IPG server 108 generates one or more e-mail messages based on the retrieved IPG data. An example of the contents of these one or more messages is shown below:

BNA2: 20:00: Duration: 60 m: Alias, CC, SPA, TV-14, HD, Sam must rescue Alice within 24 hours or go to jail.

BNA2: 21:00: Duration: 60 m: The Bachelor, CC, TV-Y, Some guy is tortured by having to choose only 4 out of 32 beautiful women who want his attention and money.

BNA2: 22:00: Duration: 60 m: Who want to be a Millionaire, CC, SPA, TV-G, HD, Regis Philbin hosts a really boring quiz show that people still watch because there is a million dollars on the line.

BNA4: 20:00: Duration: 120 m: Local News, CC, SPA, TV-A, All the days news headlines dragged out to 2 painful hours, most of which contains waterskiing squirrels.

BNA4: 22:00: Duration: 60 m: The Tonite Show, CC, SPA, TV-14, Jay Leno tells the same jokes about President Bush that he used for President Clinton back in 1994.

BNA5: 20:00: Duration: 60 m: Survivor, CC, SPA, TV-MA, HD, A show for people to watch when the do not have enough pseudo-drama working out the minutia of their own lives.

BNA5: 21:00: Duration: 120 m: Movie-The Hobbling of Jebediah Smith, CC, SPA, TV-14, HD, A man with huge feet is forced to wear small wooden shoes.

BNA17: 20:00: Duration: 240 m: NASCAR Racing, CC, TV-Y, HD, 43 drivers drive really fast in a circle for 4 hours, sometimes crashing into each other.

HBOE: 20:00: Duration: 120 m: Everwood, CC, SPA, R, HD, A modern day western with more swear words than you can shake a stick at.

HBOE: 22:00: Duration: 120 m: Circus Freaks Gone Wild, TV-MA, A good chance for people to feel better about themselves.

ESPNE: 20:00: Duration: 60 m: World Class Poker Tour, CC, SPA, TV-G, You can watch 4 complete strangers play poker.

ESPNE: 21:00: Duration: 180 m: The world of Sports, CC, SPA, TV-14, HD, Women's semifinal matches of the Canadian rules curling championships. From Alberta, Canada.

The IPG data indicates that “Alias” is on channel 2 for 60 minutes beginning at 20:00. The IPG data also indicates that closed captioning and SAP are available and that the program is in HD format. The IPG data further indicates that the program is rated TV-14 and provides a description of the program (i.e., “Sam must rescue Alice within 24 hours or go to jail.”). The other parts of the message provide similar information for other programs on channels 2, 4, 5, 17, HBOE, and ESPNE during the three-hour period starting at 20:00. The contents of the IPG data may be part of one large e-mail message or each of the individual items may be sent in its own e-mail message. As with the e-mail request message, the IPG data shown above is an English-readable version. These items can be packed or encoded in a machine-readable binary fashion and optionally encrypted.

At ST 406, IPG server 108 sends the one or more generated e-mail messages to television 102 over wide area network 106. The e-mail messages sent by IPG server 108 are compliant with a protocol (e.g., IMAP) used by e-mail client 112. The e-mail messages sent from IPG server 108 may be sent, for example, as replies to the sender e-mail address included in the IPG display request. Alternatively, the IPG display request may include an e-mail address portion specifying an e-mail address to which the generated e-mail messages should be sent.

At ST 407, television 102 receives the e-mail messages sent from IPG server 108 and stores the received messages in electronic mailbox 120 of e-mail client 112.

At ST 408, the control program of television 102 accesses the messages stored in electronic mailbox 120 and generates a display on the television screen such as that shown in FIG. 3. The generating of the display involves modifying a default grid template (or selecting one of a plurality of grid templates) based on the durations of the programs specified in the IPG data. If the e-mail message is sent to a receiver other than a television (e.g., a set-top box), an output of that receiver may be supplied to a display device (such as a television or monitor) for display on the screen thereof.

After the initial display is generated at ST 408, the viewer may navigate among the cells of the grid at ST 409 by using, for example, right, left, up and down arrow keys on a remote control associated with television 102. The viewer's navigation may necessitate a change in the IPG display. By way of example, the viewer may use right and left arrow keys on the remote control to move the cursor or highlight forward and backward in time to see programs that are viewable after 11:00 PM or before 8:00 PM. By way of further example, the viewer may use up and down arrow keys on the remote control to see programs that are viewable on channels other than channels 2, 4, 5, 17, HBOE and ESPNE. If additional IPG data is needed (ST 410), another IPG data request e-mail is sent to IPG server 108.

In another example implementation, IPG server 108 may supply IPG data sufficient to generate an initial IPG display along with IPG data for programs “surrounding” this initial display to improve navigation response time. For example, if an IPG is configured to display programs on channels 5, 7 and 9 over a two-hour time period, the IPG server may supply IPG data for this two-hour time period along with IPG data for a subsequent time period (e.g., the next hour). Thus, if a viewer were to navigate forward in time past the initially displayed two-hour period, the television can generate a new IPG display using already-received data. At the same time as the viewer navigates past the initially-displayed information, the television can send a request to the IPG server for IPG data for a further subsequent time period so that this IPG data is already available (or has at least already been requested) should the viewer continue to navigate forward in time. Similarly, the IPG server may additionally or alternatively supply IPG data for channels immediately higher and lower than the channels currently included in the IPG display. In the above example, where IPG data for channels 5, 7 and 9 is displayed, the IPG server may supply IPG data for channels 2, 4, 11 and 13. In this way, if a viewer navigates to higher or lower channels, the receiver can generate an IPG display based on already-received IPG data. Here again, at the same time navigates to one of these higher or lower channels, the television can send a request to the IPG server for additional higher and lower channels (as appropriate) so that this IPG data is already available (or has at least already been requested) should the viewer continue to navigate to higher or lower channels.

The systems and methods described herein are not limited to IPG displays for multiple channels/times. For example, the television can generate a request for IPG data (e.g., program title, program summary, actor information and starting and ending times) relating to a program on a currently-tuned channel. This information can be provided as an overlay to the program on the currently-tuned channel.

In some implementations, the viewer may use the IPG to schedule the recording of certain programs. Data relating to this recording (e.g., start time, end time, channel, etc.) may be sent via an e-mail message to IPG server 108. The IPG server stores the recording request and, at an appropriate time (e.g., shortly before the program selected for recording is scheduled to begin), sends a message to the television with control information based on the time(s) (e.g., start time, end time), input (e.g., cable or antenna) and channel that the viewer has previously selected for recording. The television responds to this message to enable the recording (e.g., by tuning the appropriate channel and turning on a recording device, for example, using an IR blaster).

While the control program herein is described with reference to the FIG. 1 example as being incorporated in a television, it will be appreciated that this control program can be implemented in a set-top box including a processing system and which generates display data for providing a display on a television or monitor coupled to the set-top box. Specifically, the set-top box may include an e-mail client for generating an e-mail message requesting interactive program guide (IPG) data, sending the e-mail message to an IPG server over a wide area network, and receiving one or more e-mail messages containing IPG data from the IPG server. A processor generates display data based on the IPG data included in the received e-mail messages and an output outputs the display data to the television or monitor.

The systems and methods described herein may be implemented in hardware, firmware, software and combinations thereof. Software or firmware may be executed by a general-purpose or specific-purpose computing device including a processing system such as a microprocessor and a microcontroller. The software may, for example, be stored on a storage medium (optical, magnetic, semiconductor or combinations thereof) and loaded into a RAM for execution by the processing system. The systems and methods described herein may also be implemented in part or whole by hardware such as application specific integrated circuits (ASICs), field programmable gate arrays (FPGAs), logic circuits and the like.

While the systems and methods have been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

I claim:

1. An interactive program guide (IPG) system comprising:
a receiver comprising a memory for storing an electronic mailbox,
an IPG server comprising an IPG data store,
wherein the receiver generates and sends an e-mail message to the IPG server over a wide area network requesting IPG data,
the IPG server retrieves IPG data from the IPG data store based on the e-mail message sent from the receiver and generates and sends to the receiver one or more e-mail messages including the retrieved IPG data, and
the receiver stores the IPG data in the messages received from the IPG server in the electronic mailbox and generates an IPG display based on the stored IPG data.

2. The IPG system according to claim 1, wherein the IPG display comprises a grid in which channels are arranged in one dimension thereof and program times are arranged in another dimension thereof.

3. The IPG system according to claim 1, wherein the receiver comprises a set-top terminal.

4. The IPG system according to claim 1, wherein the receiver comprises a television.

5. The IPG system according to claim 1, wherein the wide area network comprises the internet.

6. A method for providing an interactive program guide (IPG), comprising:
generating an e-mail message comprising a request for IPG data;
sending the e-mail message over a wide area network to an IPG data server;
receiving one or more e-mail messages over the wide area network from the IPG data server comprising IPG data responsive to the IPG data request; and
generating an IPG display based on the IPG data in the received e-mail messages.

7. The method according to claim 6, wherein the e-mail message is generated in response to receiving an input of an IPG data request.

8. The method according to claim 6, wherein the e-mail message is generated automatically.

9. A computer-readable medium which stores program code for the method for providing an interactive program guide (IPG) according to claim 6.

10. A method for providing interactive program guide (IPG) data, comprising:
receiving an e-mail message sent over a wide area network comprising a request for IPG data;
accessing an IPG data store to retrieve IPG data based on the IPG data request; and
sending over the wide area network one or more e-mail messages comprising the retrieved IPG data.

11. A computer-readable medium which stores program code for the method for providing interactive program guide (IPG) data according to claim 10.

12. A method of controlling consumer electronic devices comprising:
generating an e-mail message comprising a request for controlling a consumer electronic device;
sending the generated e-mail message over a wide area network to a server;
receiving from the server one or more e-mail messages comprising control information based on the request; and
controlling the one or more consumer electronic devices based on the control information included in the received e-mail messages.

13. The method according to claim 12, wherein the request comprises a future time for executing the control.

14. The method according to claim 12, wherein the control information comprises control information for a channel tuning operation.

15. The method according to claim 12, wherein the control information comprises control information for a record command for a recording device.

16. A television comprising:
an e-mail client for generating an e-mail message requesting interactive program guide (IPG) data, sending the e-mail message to an IPG server over a wide area network, receiving one or more e-mail messages containing IPG data from the IPG server; and
a processor for generating a display on a screen of the television based on the IPG data included in the received e-mail messages.

17. A set-top box coupled to a television or monitor, the set-top box comprising:
an e-mail client for generating an e-mail message requesting interactive program guide (IPG) data, sending the e-mail message to an IPG server over a wide area network, and receiving one or more e-mail messages containing IPG data from the IPG server;
a processor for generating display data based on the IPG data included in the received e-mail messages; and
an output for outputting the display data to the television or monitor.
